(19) United States
(12) Patent Application Publication
(10) Pub. No.: US 2014/0295396 A1
(43) Pub. Date: Oct. 2, 2014

(54) DEVICE AND METHOD FOR LEARNING SUPPORT

(71) Applicant: Fujitsu Limited, Kawasaki-shi (JP)

(72) Inventors: Takeaki Kobayashi, Yokohama (JP); Hidehiko Mayumi, Kawasaki (JP); Toshio Tanaka, Yokohama (JP); Takehiro Nabae, Chigasaki (JP); Masahiro Kawasaki, Kawasaki (JP)

(73) Assignee: Fujitsu Limited, Kawasaki-shi (JP)

(21) Appl. No.: 14/200,209

(22) Filed: Mar. 7, 2014

(30) Foreign Application Priority Data
Mar. 26, 2013 (JP) 2013-064939

(51) Int. Cl. G09B 5/08

(52) U.S. Cl. CPC G09B 5/08
USPC 434/350

(57) ABSTRACT

A computer-readable storage medium storing a computer executable program that, when executed, causes a computer to perform a method for learning support includes collecting a first opinion information and a second opinion information from a plurality of information terminals of a group, determining whether a representative opinion information of a group is included in a majority opinion information among collected opinion information of a first opinion information and a second opinion information, and outputting a minority opinion information among the collected opinion information when the representative opinion information is included in the majority opinion information.

### CROSS-REFERENCE TO RELATED APPLICATION

This application is based upon and claims the benefit of priority from the prior Japanese Patent Application No. 2013-064939 filed on Mar. 26, 2013, the entire contents of which are incorporated herein by reference.

### FIELD

The present disclosure relates to a learning support device and a learning support method that support discussions conducted in a group.

### BACKGROUND

Verification tests of next-generation education have been conducted using electronic information terminals such as a tablet terminal, and it is anticipated that the next-generation education will be spread out nationwide.

A type of class using the information terminal is known in which the same assignment are given to all the students and the students are divided into a plurality of groups by the teacher for discussions on the assignment. The students may input the result of discussions conducted in each group for the assignment to the information terminal as a group opinion, and transmit the input result of the discussions to the teacher. In this type of class, the group opinion transmitted to the teacher's terminal is displayed on a screen from, for example, the teacher's terminal, and is used to present the group opinion or for the discussion of the entire class as well.

See, for example, Japanese Patent Application Laid-Open No. 2003-187066.

When it is determined, for example, that a representative opinion is regarding an approval or disapproval of the assignment, there is a possibility that a student may simply accept an opinion considered to be desirable without thinking too much. As a result, it is likely that the discussion in a group is simply prone to progress to a direction in which the assignment is reviewed from a one-sided veiwpoint considered as desirable. In this case, the discussion in a group may be progressed on the premise that any one of the approval and disapproval is determined and thus, there is a concern that the assignment may be reviewed from only a one-sided viewpoint.

One aspect of the present disclosure intends to provide a program, a device and a method that support learning in order to review an assignment from a plurality of viewpoints when a group discusses the assignment.

### SUMMARY

According to one aspect of the present disclosure, there is provided a computer-readable storage medium storing a computer executable program that, when executed, causes a computer to perform a method for learning support including: collecting a first opinion information and a second opinion information from a plurality of information terminals of a group; determining whether a representative opinion information of a group is included in a majority opinion information among collected opinion information of a first opinion information and a second opinion information; and outputting a minority opinion information among the collected opinion information when the representative opinion information is included in the majority opinion information.

The object and advantages of the disclosure will be realized and attained by the elements and combinations particularly pointed out in the claims. It is to be understood that both the foregoing general descriptions and the following detailed descriptions are exemplary and explanatory, and are not restrictive of the invention, as claimed.

The respective processes described above may be performed by functional units implementing the respective processes, by a method causing the computer to execute the processes as a procedural sequence, or by a computer-readable storage medium having stored a program therein.

According to the present disclosure, it is possible to support the discussions of a group so that the assignment may be reviewed or considered from a plurality of viewpoints.

### BRIEF DESCRIPTION OF DRAWINGS

FIG. 1 is a view illustrating an exemplary configuration of a learning support system.

FIG. 2 is a view illustrating an exemplary hardware configuration of a teacher terminal.

FIG. 3 is a view illustrating an exemplary student database.

FIG. 4 is a view illustrating an exemplary assignment database.

FIG. 5 is a first view illustrating an exemplary student opinion database.

FIG. 6 is a first view illustrating an exemplary group opinion database.

FIG. 7 is a first view explaining the functions of a teacher terminal.

FIG. 8A-8C are a first flowchart explaining the operations of the teacher terminal.

FIG. 9 is a first flowchart explaining the processes of a grouping unit.

FIG. 10 is a second flowchart explaining the processes of the grouping unit.

FIG. 11 is a flowchart explaining the processes of a message notification unit.

FIG. 12 is a view illustrating an exemplary assignment selection screen displayed on the teacher terminal.

FIG. 13 is a view illustrating an exemplary reply screen displayed on a student terminal.

FIG. 14 is a view illustrating an exemplary student opinion list screen displayed on the teacher terminal.

FIG. 15 is a view illustrating another exemplary student opinion list screen displayed on the teacher terminal.

FIG. 16 is a first view illustrating an exemplary discussion content transmission screen of a primary discussion displayed on the student terminal.

FIG. 17 is a second view illustrating the exemplary discussion content transmission screen of the primary discussion displayed on the student terminal.

FIG. 18 is a third view illustrating the exemplary discussion content transmission screen of the primary discussion displayed on the student terminal.

FIG. 19 is a view illustrating an exemplary student opinion database in which an influence opinion flag is set.

FIG. 20 is a first view illustrating an exemplary group opinion screen displayed on the teacher terminal.

FIG. 21 is a first view illustrating an exemplary discussion content transmission screen of a secondary discussion displayed on the student terminal.

FIG. 22 is a second view illustrating the exemplary discussion content transmission screen of the secondary discussion displayed on the student terminal.

FIG. 23 is a view illustrating an exemplary group opinion database in which the result of the secondary discussion is stored.

FIG. 24 is a second view illustrating the exemplary group opinion screen displayed on the teacher terminal.

FIG. 25 is a fourth view illustrating the exemplary discussion content transmission screen of the primary discussion displayed on the student terminal.

### DESCRIPTION OF EMBODIMENTS

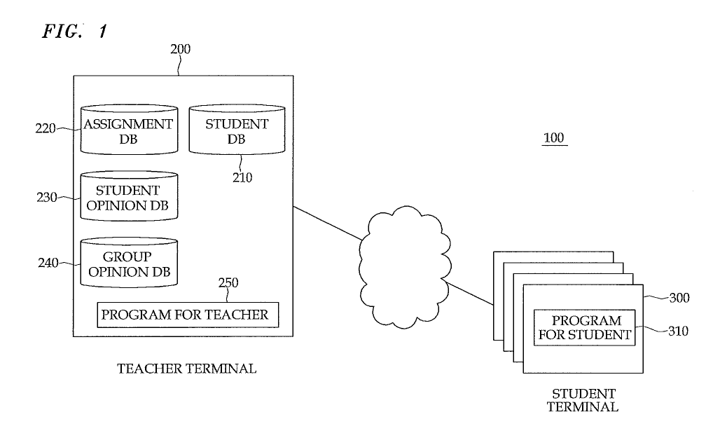

Hereinbelow, exemplary embodiments will be described with reference to accompanying drawings. FIG. 1 is a view illustrating an exemplary configuration of a learning support system.

A learning support system 100 of the present embodiment includes a learning support server 200 and a plurality of information terminals 300. The learning support server 200 and the plurality of information terminals 300 of the present embodiment are connected with each other through a network.

The learning support system 100 of the present embodiment may be used in a class in which the same assignment are given to all the students of the class and the students are divided into a plurality of groups to arrange the result of the discussions conducted in a group for the assignment as a group opinion. The group opinion of the present embodiment includes, for example, an approval or disapproval for the assignment and a representative opinion of a group determined within the group.

When the learning support system 100 of the present embodiment is used in the class, the learning support server 200 serves as a terminal for a teacher and the information terminal 300 serves as a terminal for a student. Accordingly, in the following description, the learning support server 200 and the information terminal 300 are referred to as the teacher terminal 200 and the student terminal 300, respectively.

Each of the teacher terminal 200 and the student terminal 300 may be a tablet terminal. Further, the teacher terminal 200 may be, for example, a desktop computer or a notebook computer, and the student terminal 300 may be a tablet terminal.

The teacher terminal 200 of the present embodiment includes a student database 210, an assignment database 220, a student opinion database 230, and a group opinion database 240, and the teach terminal 200 is installed with a program for teacher 250. The program for teacher 250 of the present embodiment includes a learning support program.

The student terminal 300 of the present embodiment is installed with a program for student 310. The program for student 310 of the present embodiment causes the student terminal 300 to execute a process to be described in the learning support system 100 of the present embodiment.

In the learning support system 100 of the present embodiment, the teacher terminal 200 supports discussions to be conducted in each group such that the assignment is reviewed from both viewpoints of approval or disapproval in the discussion. More specifically, when there is a bias in the opinion of approval or disapproval (approval or disapproval) of each student within a group, the teacher terminal 200 transmits the subject for discussion to the student terminal 300 in order for the assignment to be reviewed from both viewpoints of the majority and the minority.

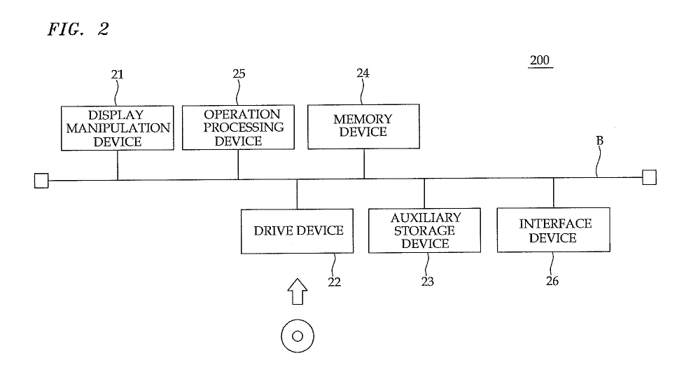

FIG. 2 is a view illustrating an exemplary hardware configuration of the teacher terminal 200. The teacher terminal 200 of the present embodiment includes a display manipulation device 21, a drive device 22, an auxiliary storage device 23, a memory device 24, an operation processing device 25 and an interface device 26, and these devices are connected with one another through a bus B.

The display manipulation device 21 is, for example, a touch panel, and is used to input various signals and display various information.

The interface device 26 includes, for example, a modem, or a LAN card, and used for connecting to the network.

The program for teacher 250 constitutes at least a portion of various programs that control the teacher terminal 200. The program for teacher 250 is provided by, for example, a distribution of the recording medium 27 or download from the network. The recording medium 27 having the program for teacher 250 recorded therein may utilize various types of recording medium, such as, for example, a CD-ROM, a flexible disk, and an opto-magnetic disk which records information optically, electrically or magnetically, and a semiconductor memory such as, for example, a ROM, and a flash memory which record information electrically.

When the recording medium 27 having the program for teacher 250 recorded therein is set in the drive device 22, the program for teacher 250 is installed in the auxiliary storage device 23 from the recording medium 27 through the drive device 22. The program for teacher 250 downloaded from the network is installed in the auxiliary storage device 23 through the interface device 26.

The auxiliary storage device 23 stores, for example, necessary files and data while storing the installed program for teacher 250. The memory device 24 reads out and stores the program for teacher 250 from the auxiliary storage device 23 when a computer is activated. Also, the operation processing device 25 implements various processes to be described below according to the program for teacher 250 stored in the memory device 24.

The teacher terminal 200 of the present embodiment may be, for example, a desktop computer or a notebook computer. In this case, the teacher terminal 200 includes an input device, such as a keyboard or a mouse, and an output device, such as a display, instead of the display manipulation device 21.

The hardware configuration of the student terminal 300 of the present embodiment is similar to that of the teacher terminal 200 and thus, descriptions thereof will be omitted.

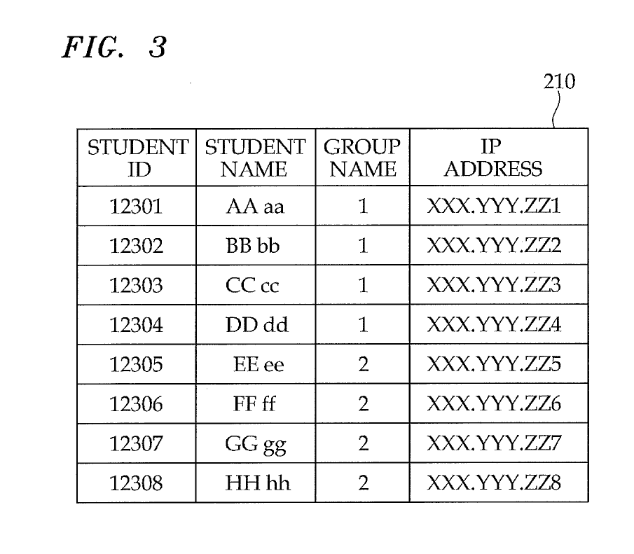

Hereinbelow, each database stored in the teacher terminal 200 will be described with reference to FIG. 3 to FIG. 6. Each database of the present embodiment is stored in, for example, a predetermined area of the auxiliary storage device 23 or the memory device 24 of the teacher terminal 200.

FIG. 3 is a view illustrating an exemplary student database. The student database 210 of the present embodiment may be registered in advance by, for example, the teacher who manipulates the teacher terminal 200. A student identifier (student ID) allocated for each student terminal 300, a student name, a group name within which the student belongs, and an IP address of the student terminal 300 are stored to be associated with each other in the student database 210.

The IP address is information which identifies the student terminal 300. Further, the student IDs are grouped and a group name is given to the student ID by the process of the program for teacher 250 to be described below in the present embodiment. The example of FIG. 3 is an example in which the group name is given.

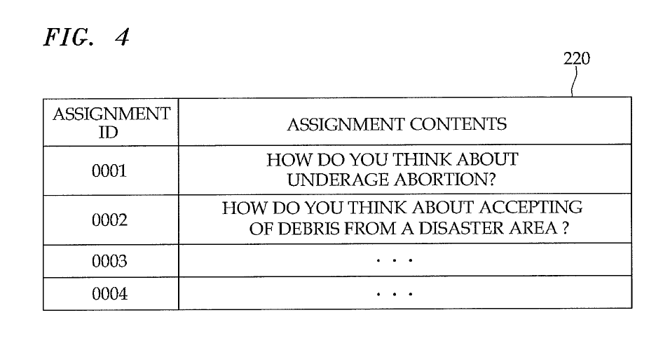

FIG. 4 is a view illustrating an exemplary assignment database. The assignment database 220 of the present embodiment may be registered in advance by, for example, the teacher who manipulates the teacher terminal 200. An assignment ID given for each assignment and the content of assignment are stored to be associated with each other in the assignment database 220 of the present embodiment.

The assignment in the present embodiment indicates questions or topics for discussion given to each student. Further, the assignment of the present embodiment is actually the text data representing the content of the assignment, but in the following descriptions, the text data representing the content of the assignment is referred to as the assignment.

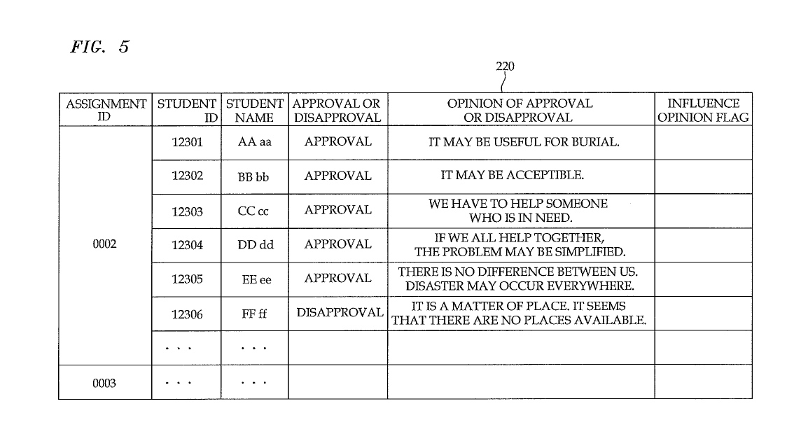

FIG. 5 is a first view illustrating an exemplary student opinion database.

In the student opinion database 230 of the present embodiment, student ID, student name, information of approval or disapproval which indicates the approval or disapproval of the student, opinion information of approval or disapproval for the assignment of the student, and an influence opinion flag field indicating the presence/absence of the influence opinion flag are stored to be associated with one another for each assignment ID. When any of the approval or disapproval is selected in a reply screen, which will be described below, displayed in the student terminal 300, the information of approval or disapproval is stored in the student opinion database 230. When the opinion information of approval or disapproval is input in the reply screen, which will be described below, displayed in the student terminal 300, the opinion information of approval or disapproval is stored in the student opinion database 230. Further, the information including the information of approval or disapproval and the opinion information of approval or disapproval is referred to as an opinion information in the present embodiment.

The information of the approval or disapproval of the present embodiment is, for example, information indicating which one of the approval or disapproval is selected. In the following description, the information of approval or disapproval is referred to as the approval or disapproval. Further, the opinion information of approval or disapproval of the present embodiment is, for example, the text data inputted to be associated with the approval or disapproval selected in the student terminal 300. In the following description, the opinion information of approval or disapproval is referred to as an opinion of approval or disapproval. The influence opinion flag of the present embodiment will be described below.

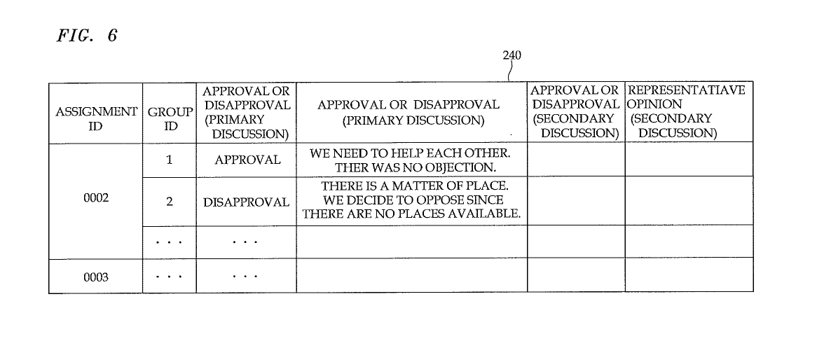

FIG. 6 is a view illustrating an exemplary group opinion database. The representative opinion information of the group is stored in the group opinion database 240 after a group discussion is conducted for the assignment. The approval or disapproval as a group opinion and the opinion of approval or disapproval determined within the group are included in the representative opinion information of the group of the present embodiment. In the following description, the opinion of approval or disapproval determined within the group is referred to as a representative opinion of a group.

In the group opinion database 240 of the present embodiment, the group ID, the approval or disapproval in the primary discussion, the representative opinion in the primary discussion, the approval or disapproval in the secondary discussion and the representative opinion in the secondary discussion are stored to be associated with one another for each assignment ID.

The primary discussion refers to a first discussion conducted in a group after the assignment is given. The secondary discussion refers to a second discussion conducted in the group when the assignment is given again after the group opinion for the assignment is determined by the primary discussion.

The group opinion database 240 of the present embodiment is updated each time when the group discussion is progressed, and the approval or disapproval or the representative opinion for each group is transmitted to the teacher terminal 200.

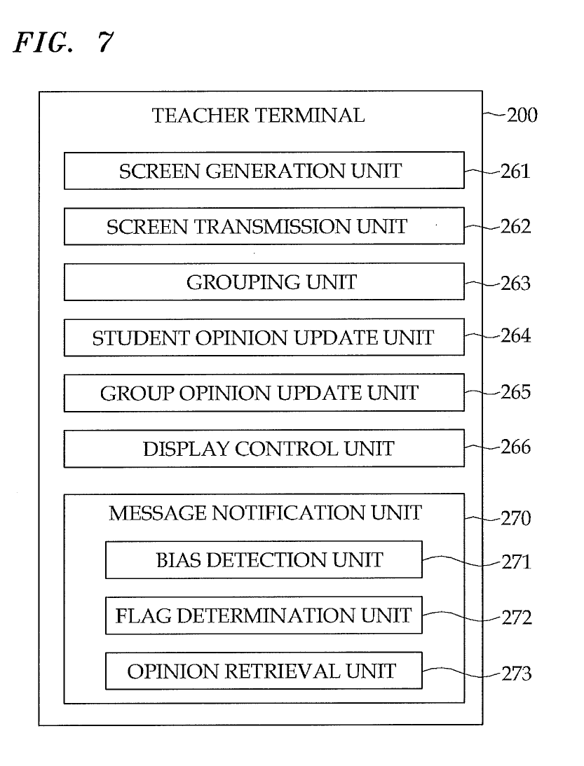

The function of the teacher terminal 200 of the present embodiment will be described with reference to FIG. 7. The process of each unit to be described below may be implemented by executing the program for teacher 250. FIG. 7 is a view explaining the function of the teacher terminal.

The teacher terminal 200 of the present embodiment includes a screen generation unit 261, a screen transmission unit 262, a grouping unit 263, a student opinion update unit 264, a group opinion update unit 265, a display control unit 266, and a message notification unit 270.

The screen generation unit 261 generates various screens to be described below. The screen transmission unit 262 transmits various screens prepared by the screen generation unit 261 to the student terminal 300 which is the destination of the transmission. The grouping unit 263 divides the students into multiple groups. More specifically, the grouping unit 263 refers to the student database 210 and the number of students of the group to be described below to allocate the group name to the student ID. When the approval or disapproval and the opinion of approval or disapproval for the assignment for each student are received from the student terminal 300, the student opinion update unit 264 updates the student opinion database 230. When the approval or disapproval and the representative opinion for the assignment for each group are received from the student terminal 300, the group opinion update unit 265 updates the group opinion database 240. The display control unit 266 controls displaying by the teacher terminal 200.

The message notification unit 270 specifies a group required to conduct the secondary discussion and notifies the specified group of a message indicating the subject for the secondary discussion.

The message notification unit 270 of the present embodiment includes a bias detection unit 271, a flag determination unit 272 and a opinion retrieval unit 273. The group required to conduct the secondary discussion is specified by the bias detection unit 271 and the flag determination unit 272 in the present embodiment.

The bias detection unit 271 detects a biased opinion in the approval or disapproval for the assignment of each student of the group. The flag determination unit 272 refers to the student opinion database 230 to determine whether the influence opinion flag is set for the opinion of approval or disapproval of the student within the group. The opinion retrieval unit 273 retrieves an opinion of approval or disapproval which is the subject for the secondary discussion from the opinions of approval or disapproval of the students of other groups. Details of the process of each unit provided in the message notification unit 270 of the present embodiment will be described below.

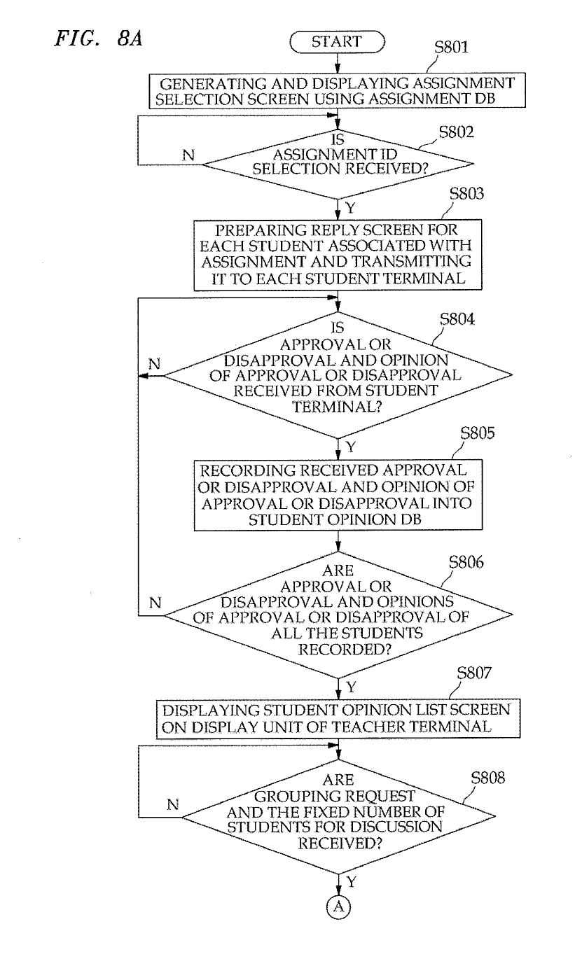

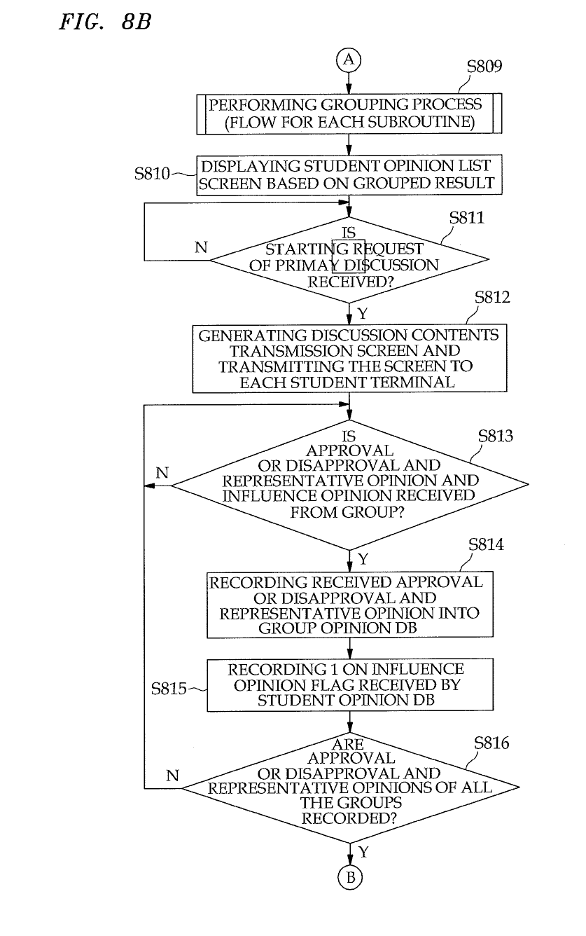

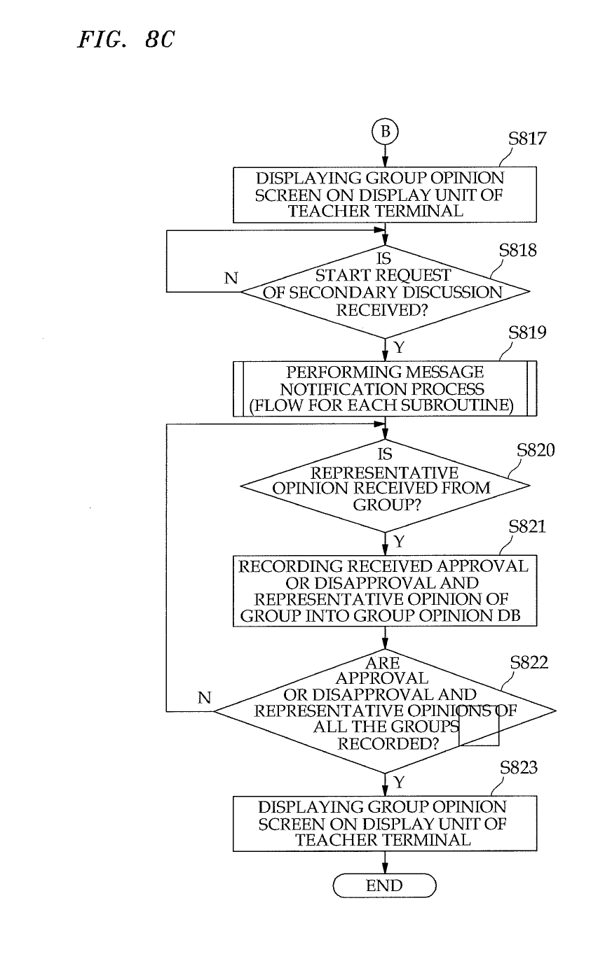

The operations of the teacher terminal 200 of the present embodiment will be described hereinbelow with reference to FIG. 8. FIG. 8 is a first flowchart illustrating the operations of the teacher terminal 200.

The teacher terminal 200 of the present embodiment causes the display control unit 266 to generate an assignment selection screen by referring to the assignment database 220 and display the assignment selection screen on the display manipulation device 21 (step S801). Subsequently, the teacher terminal 200 determines whether an assignment ID is selected in the assignment selection screen (step S802). At step S802, when it is determined that the assignment ID is not selected, the teacher terminal 200 waits until the assignment ID is selected.

When it is determined that the assignment ID is selected at step S802, the teacher terminal 200 generates a reply screen for each student associated with the selected assignment ID using the screen generation unit 261 and transmits the reply screen to the student terminal 300 using the screen transmission unit 262 (step S803). Subsequently, the teacher terminal 200 determines whether the approval or disapproval and the opinion of approval or disapproval input to the reply screen in the student terminal 300 are received (step S804). When it is determined that the approval or disapproval and the opinion of approval or disapproval are not received at step S804, the teacher terminal 200 waits until the approval or disapproval and the opinion of approval or disapproval are received.

When it is determined that the approval or disapproval and the opinion of approval or disapproval are received from the student terminal 300 at step S804, the teacher terminal 200 updates the student opinion database 230 using the student opinion update unit 264 (step S805). Subsequently, the teacher terminal 200 refers to the student opinion database 230 to determine whether the approval or disapproval, and the opinions of approval or disapproval of all the student attended in the class are stored in the student opinion database 230 (step S806). When it is determined that the approval or disapproval and the opinions of approval or disapproval of all the student are not stored at step S806, the teacher terminal 200 goes back to step S804.

When it is determined that the approval or disapproval and the opinions of approval or disapproval of all the student are stored at step S806, the teacher terminal 200 causes the display control unit 266 to display a student opinion list screen on the display manipulation device 21 (step S807).

Subsequently, the grouping unit 263 of the teacher terminal 200 determines whether the grouping request and the fixed number of students of the group are received in the student opinion list screen (step S808). When it is determined that the grouping request and the fixed number of students of the group are not received at step S808, the teacher terminal 200 waits until the grouping request and the fixed number of students of the group are received.

When it is determined that the grouping request and the fixed number of students of the group are received at step S808, the grouping unit 263 performs the grouping process (step S809). Details of the grouping process will be described below.

When the grouping process is completed at step S809, the teacher terminal 200 causes the display control unit 266 to display the student opinion list screen in which a result from the grouping process is reflected on the display manipulation device 21 (step S810).

Subsequently, the teacher terminal 200 determines whether the primary discussion start request is received in the student opinion list screen (step S811). When it is determined that the primary discussion start request is not received at step S811, the teacher terminal 200 waits until the primary discussion start request is received. When it is determined that the primary discussion start request is received at step S811, the screen generation unit 261 generates the discussion content transmission screen and the screen transmission unit 262 transmits the generated screen to the student terminal 300 (step S812).

Subsequently, the teacher terminal 200 determines whether the representative opinion of each group and an influence opinion selected from the opinion of approval or disapproval of each student within the group are received in each group (step S813). The influence opinion of the present embodiment is regarded as, for example, the opinion of approval or disapproval which has influenced on opinions of the students within the group when the representative opinion is determined by the group discussion, and also is an opinion of approval or disapproval selected by the students. When it is determined that the representative opinion and the influence opinion are not received at step S813, the teacher terminal 200 waits until the representative opinion and an influence opinion are received.

When it is determined that the representative opinion and the influence opinion are received at step S813, the teacher terminal 200 stores the representative opinion in the group opinion database 240 using the group opinion update unit 265 (step S814). Subsequently, the teacher terminal 200 sets an influence opinion flag in an influence opinion flag field associated with the student ID of the student, whose opinion is selected as the influence opinion, using the student opinion update unit 264 (step S815).

Subsequently, the teacher terminal 200 determines whether the representative opinions with respect to all the groups are stored in the group opinion database 240 (step S816). When it is determined that the representative opinions of all the groups are not stored at step S816, the teacher terminal 200 goes back to step S813. When it is determined the representative opinions of all the groups are stored at step S816, the teacher terminal 200 causes the display control unit 266 to display a group opinion display screen on the display manipulation device 21 (step S817).

Subsequently, the teacher terminal 200 determines whether the secondary discussion start request is received in the group opinion display screen (step S818). When it is determined that the secondary discussion start request is not received at step S818, the teacher terminal 200 waits until the secondary discussion start request is received.

When it is determined that the secondary discussion start request is received at step S818, the teacher terminal 200 conducts a message notification process using a message notification unit 270 (step S819). Details of the message notification process will be described below.

Subsequently, the teacher terminal 200 determines whether the representative opinion is received from each group (step S820). When it is determined that the representative opinion is not received at step S820, the teacher terminal 200 waits until the representative opinion is received. When it is determined that the representative opinion is received at step S820, the teacher terminal 200 stores the received representative opinion in the group opinion database 240 using the group opinion update unit 265 (step S821).

Subsequently, the teacher terminal 200 determines whether the representative opinions in the secondary discussion of all the groups are stored in the group opinion database 240 (step S822). When it is determined that the representative opinions in the secondary discussion of all the groups are not stored at step S822, the process of the teacher terminal 200 goes back to step S820. When it is determined that the representative opinions in the secondary discussion of all the groups are stored at step S822, the teacher terminal 200 causes the display control unit 266 to display the group opinion screen in which the representative opinion of the secondary discussion is reflected on the display manipulation device 21 (step S823), and ends the process.

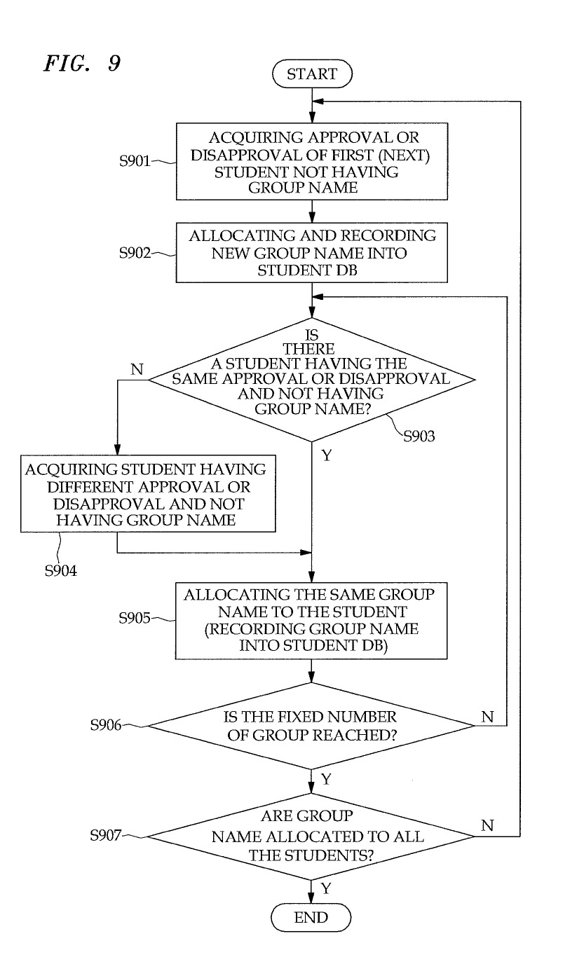

Subsequently, a process of the grouping unit 263 at step S809 will be described with reference to FIG. 9. FIG. 9 is a first flowchart illustrating a process of a grouping unit.

The grouping unit 263 refers to the student database 210 and the student opinion database 230 to acquire the approval or disapproval of a top student ID among the student IDs of which the group name is not stored (step S901). The top student ID may be a student ID having the smallest number.

Subsequently, the grouping unit 263 allocates a group name to the acquired student ID and stores the allocated group name in the student database 210 (step S902). Subsequently, the grouping unit 263 refers to the student database 210 and the student opinion database 230 to determine whether a student ID to which a group is not allocated and having the same approval or disapproval as that of the acquired student ID is present (step S903).

When it is determined that a corresponding student ID which satisfies the determination condition is not present at step S903, the student ID having a different approval or disapproval and to which the group name is not allocated is acquired (step S904). When it is determined that the corresponding student ID is present at step S903, the group name allocated at step S902 is allocated to the corresponding student (step S905).

Subsequently, the grouping unit 263 determines whether the number of students reaches the fixed number of students of the group (step S906). When it is determined that the number of students does not reach the fixed number of students of the group at step S906, the grouping unit 263 goes back to step S903. When it is determined that the number of students reaches the fixed number of students of the group at step S906, the grouping unit 263 determines whether the group name is allocated to all the student IDs (step S907). When it is determined that the group name is not allocated to all of the student IDs at step S907, the grouping unit 263 goes back to step S901. When it is determined that the group name is allocated to all of the student IDs at step S907, the grouping unit 263 ends the process.

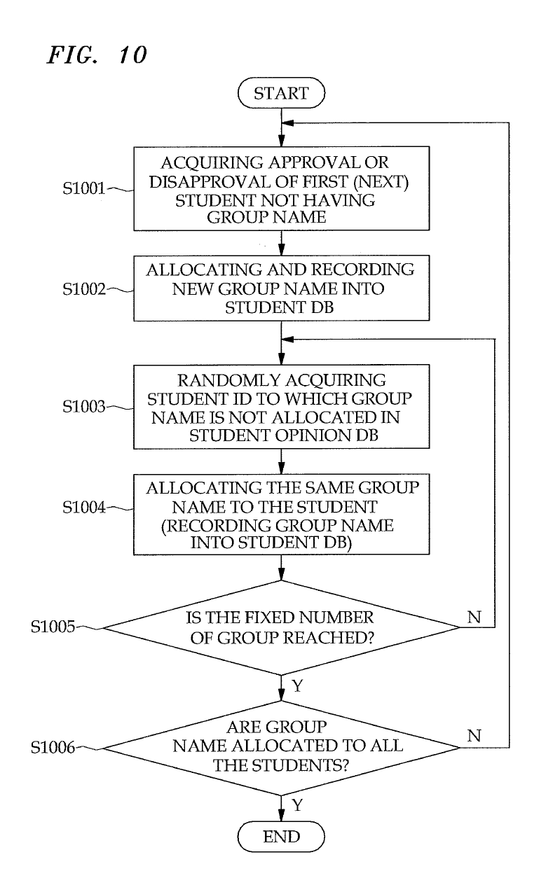

In the meantime, the grouping process by the grouping unit 263 of the present embodiment is not limited to the process described above. The grouping unit 263 of the present embodiment may perform grouping, for example, randomly. In the following description, another example of the grouping process by the grouping unit 263 of the present embodiment will be described with reference to FIG. 10.

FIG. 10 is a second flowchart explaining the process of the grouping unit.

The grouping unit 263 refers to the student database 210 and the student opinion database 230 to acquire the approval or disapproval of a top student ID, of which the group name is not stored, among the student IDs (step S1001). The top student ID may be a student ID having the smallest number. Subsequently, the grouping unit 263 allocates a group name to the acquired student ID and stores the allocated group name in the student database 210 (step S1002).

Subsequently, the grouping unit 263 randomly acquires the student ID of which the group name is not stored from the student opinion database 230 (step S1003). Subsequently, the grouping unit 263 allocates the group name allocated at step S1002 to the acquired student ID (step S1004). Specifically, the grouping unit 263 stores the group name allocated at step S1002 in the group name field associated with the student ID acquired at step S1003 in the student opinion database 230.

Subsequently, the grouping unit 263 determines whether the number of students reaches the fixed number of students of the group (step S1005). When it is determined that the number of students does not reach the fixed number of students of the group at step S1005, the grouping unit 263 goes back to step S1003. When it is determined that the number of students reaches the fixed number of students of the group at step S1005, the grouping unit 263 determines whether the group name is allocated to all the student in the student database 210 (step S1006). When it is determined that the group name is not allocated to all the student IDs at step S1006, the grouping unit 263 goes back to step S1001. When it is determined that the group name is allocated to all of the student ID at step S1006, the grouping unit 263 ends the process.

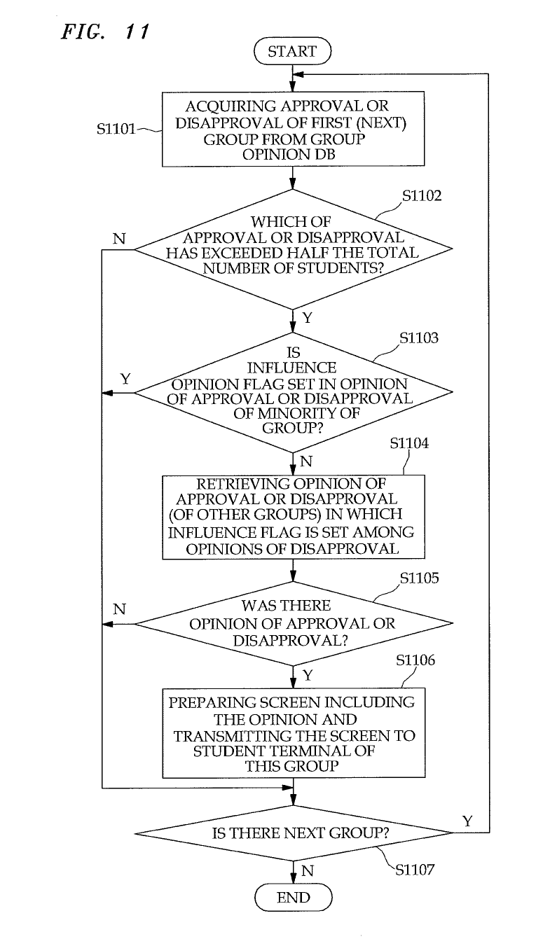

Subsequently, a process of the message notification unit 270 at step S819 of FIG. 8 will be described with reference to FIG. 11. FIG. 11 is a flowchart explaining the process of the message notification unit.

In the message notification unit 270, the bias detection unit 271 refers to the student database 210 and the student opinion database 230 to acquire the approval or disapproval of each student within a first group (step S1101). Subsequently, the bias detection unit 271 determines whether which one of the approval and disapproval in the approval and disapproval of each group has exceeded half the total number of students (step S1102).

When it is determined that any of the approval and disapproval does not exceed half the total number of students at step S1102, the message notification unit 270 goes back to step S1107 to be described below. When it is determined that any of the approval and disapproval has exceeded half the total number of students at step S1102, the flag determination unit 272 refers to the student database 210 and the student opinion database 230 to determine whether the influence opinion flag is set in the opinion of approval or disapproval of a minority within the group (step S1103).

When it is determined that the influence opinion flag is set at step S1103, the message notification unit 270 goes to step S1107 to be described below. When it is determined that the influence opinion flag is not set at step S1103, the opinion retrieval unit 273 retrieves the opinion of approval or disapproval of another group which has the same approval or disapproval as that of the minority at step S1102 and for which the influence opinion flag is set from the student opinion database 230 (step S1104).

Here, details of the step S1103 will be described. At step S1103 of the present embodiment, it is determined whether the approval or disapproval expressed by the majority students is determined as the approval or disapproval of the group in the approval or disapproval of each student within the group. The influence opinion flag indicates an opinion which has influenced on opinions of other students upon determining the approval or disapproval and the representative opinion of the group. Accordingly, the influence opinion flag is set in the opinion of approval or disapproval selected as the approval or disapproval of the group among the approval or disapproval for the assignment.

Accordingly, a case where the influence opinion flag is not set with respect to the opinion of approval or disapproval of the minority indicates that the influence opinion flag is set with respect to the opinion of approval or disapproval of the majority, and the opinion of the majority is determined as the approval or disapproval of the group.

Further, for example, in a case where the opinion of the majority is determined as the approval or disapproval of the group as well as the influence opinion flag is set with respect to the opinion of approval or disapproval of the minority, discussion for the opinion of approval or disapproval of the minority is conducted to a certain extent with which the students feel enough that the opinion of approval or disapproval of the minority influences on determining the representative opinion. Accordingly, in this case, it is determined that the discussion is conducted from both viewpoints of approval and disapproval.

Subsequently, the screen generation unit 261 determines whether the corresponding opinion of approval or disapproval satisfying the determination condition is present using the opinion retrieval unit 273 (step S1105). When it is determined that the corresponding opinion of approval or disapproval satisfying the determination condition not is present at step S1105, the message notification unit 270 goes to step S1107 to be described below. When it is determined that the corresponding opinion of approval or disapproval is present at step S1105, the screen generation unit 261 generates a discussion content transmission screen including a message in which the corresponding opinion of approval or disapproval is included and the screen transmission unit 262 transmits the generated screen to the student terminal 300 of the student of the group (step S1106). Here, the discussion content generation screen is a screen which urges the start of the secondary discussion.

Subsequently, the message notification unit 270 determines whether the next group is present (step S1107). When it is determined that the next group is present at step S1107, the message notification unit 270 goes back to step S1101. When it is determined that the next group is not present at step S1107, the message notification unit 270 ends the process.

As described above, in the present embodiment, in a case where the approval or disapproval for the assignment is biased toward one of viewpoints of the approval or disapproval within the group as well as the influence opinion flag is not set in the opinion of approval or disapproval of the minority within the group, it is determined that the representative opinion is the same as the opinion of the majority and the primary discussion is a discussion which is biased toward one of viewpoints of the approval or disapproval. Therefore, in the present embodiment, the opinion of approval or disapproval having the same approval or disapproval as that of the minority opinion within the group as well as considered as having influenced upon determining the representative opinion within the other groups is provided as the subject for the discussion to the group to urge the start of the secondary discussion.

The process of the teacher terminal 200 of the present embodiment will be described in detail hereinbelow with reference to the example of the screens displayed on the teacher terminal 200 and the student terminal 300.

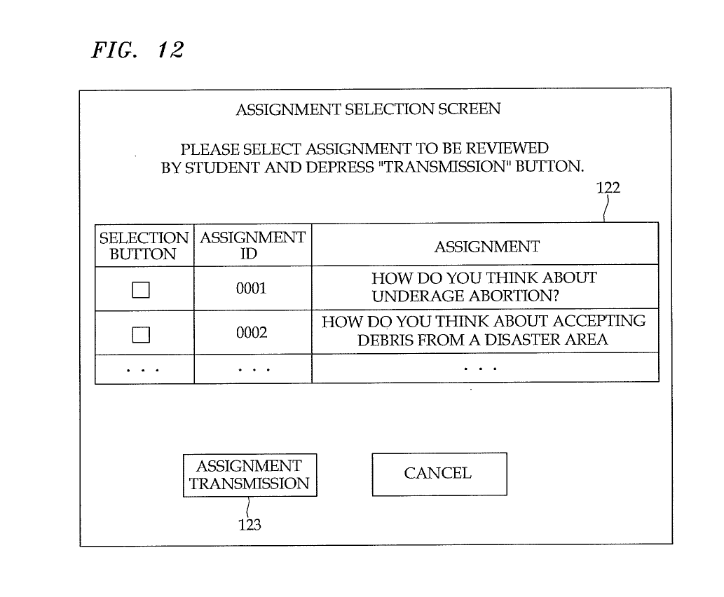

FIG. 12 is a view illustrating an example of an assignment selection screen displayed on the teacher terminal. When the assignment is selected using the selection button 122 and the assignment transmits button 123 is manipulated in the assignment selection screen 121, the teacher terminal 200 of the present embodiment generates a reply screen of the selected assignment using the screen generation unit 261.

In the following example, a case will be described where the assignment ID 0002 is selected in the assignment selection screen 121.

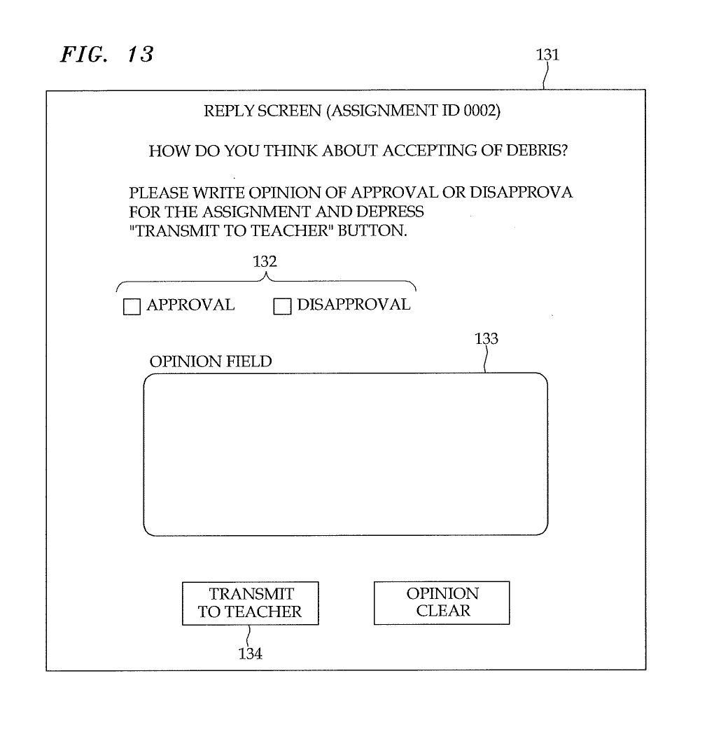

FIG. 13 is a view illustrating an example of a reply screen displayed on a student terminal. The reply screen 131 illustrated in FIG. 13 is associated with the assignment ID 0002. The teacher terminal 200 of the present embodiment transmits the reply screen 131 to the student terminals 300 of all of the students who attend the class.

When a transmission button 134 for replying is manipulated after the approval or disapproval for the assignment is selected using the selection field 132 of the approval or disapproval, and the opinion of approval or disapproval of the student is input to the opinion field 133 in the reply screen 131, the student terminal 300 transmits the selected approval or disapproval along with the inputted opinion of approval or disapproval to the teacher terminal 200. When the approval or disapproval and the opinion of approval or disapproval are received from the student terminal 300, the teacher terminal 200 updates the student opinion database 230 using the student opinion update unit 264.

The student opinion database 230 illustrated in FIG. 5 is an example in which the approval or disapproval as well as the opinion of approval or disapproval for the assignment having an assignment ID of 0002 received from the student terminal 300 is stored.

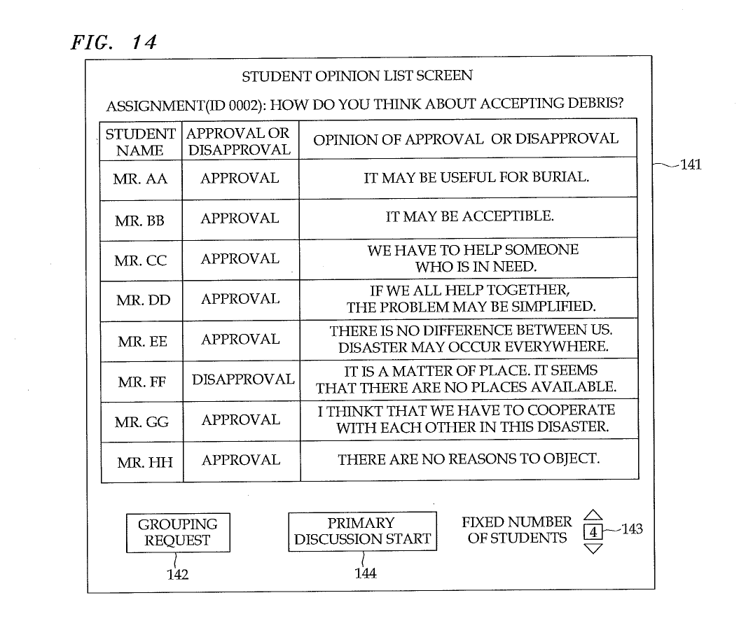

FIG. 14 is a view illustrating an example of a student opinion list screen displayed on the teacher terminal. When the approval or disapproval and the opinions of approval or disapproval of all the students are stored in the student opinion database 230, the teacher terminal 200 of the present embodiment causes the display manipulation device 21 to display the student opinion list screen 141 thereon.

The list in which the student name, the approval or disapproval and the opinion of approval or disapproval are associated with one another is displayed in the student opinion list screen 141. Further, a grouping request button 142 for requesting the grouping and an input button 143 for inputting the fixed number of students of the group are displayed in the student opinion list screen 141. Further, a primary discussion start button 144 for requesting the start of the primary discussion is displayed in the student opinion list screen 141.

When the fixed number of students of the group is input by the input button 143 and the grouping request by the manipulation of the grouping request button 142 is received in the student opinion list screen 141, the teacher terminal 200 starts the process by the grouping unit 263.

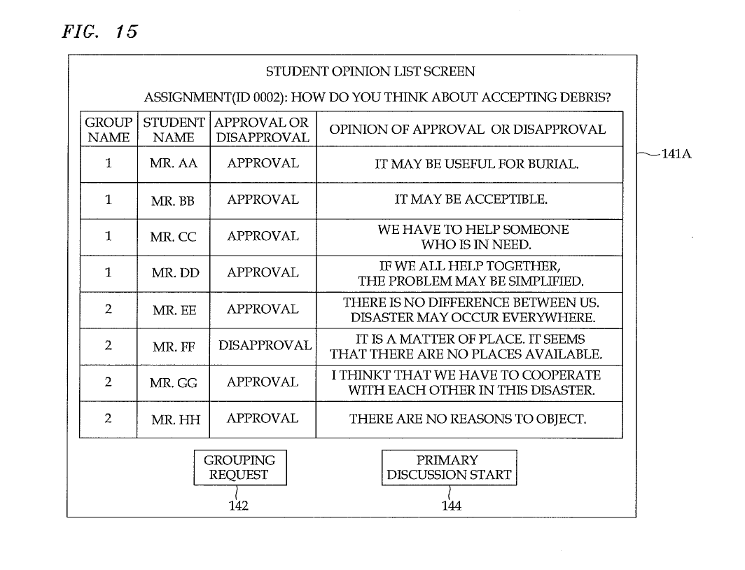

FIG. 15 is a view illustrating another example of the student opinion list screen displayed on the teacher terminal. The student opinion list screen 141A illustrated in FIG. 15 is the student opinion list screen after completion of the process by the grouping unit 263. A student name and a group name are displayed to be associated with each other in the student opinion list screen 141A. Further, since the grouping has been completed and thus, the input button 143 for inputting the fixed number of students of the group is removed in the student opinion list screen 141A. It may be shown that the fixed number of students of the group is 4 (four), and Mr. AA, Mr. BB, Mr. CC and Mr. DD are grouped in group 1 in the example of FIG. 15.

When the primary discussion start request is received due to the manipulation of the primary discussion start button 144 in the student opinion list screen 141A, the teacher terminal 200 of the present embodiment generates a discussion content transmission screen for each group and transmits the discussion content transmission screen to the student terminal 300.

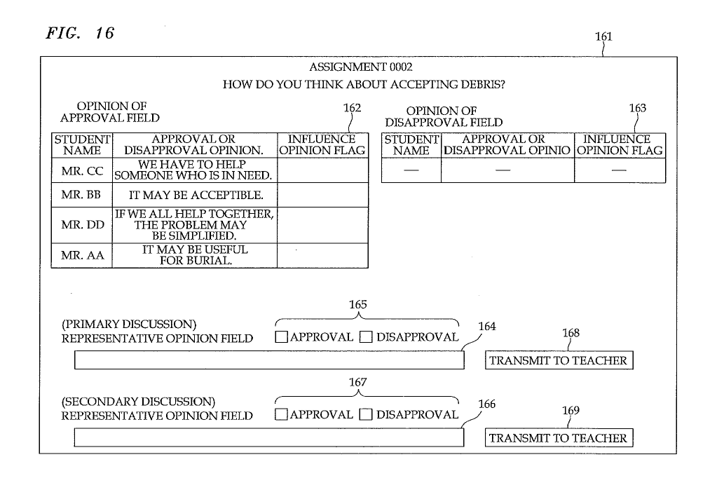

FIG. 16 is a first view illustrating an exemplary discussion content transmission screen of a primary discussion displayed on the student terminal 300. The discussion content transmission screen 161 illustrated in FIG. 16 is a screen displayed in the student terminal 300 of a student who plays the role of the chairperson in discussion among the students of the group 1. In the present embodiment, for example, when the grouping is conducted by the grouping unit 263, a student who plays the role of the chairperson in a single group may be randomly selected. In this case, for example, a chairperson flag may be set with respect to the student ID of the student selected as a student who plays the role of the chairperson within the group in the student database 210.

An approval opinion field 162 for displaying an opinion of approval for an assignment and a disapproval opinion field 163 for displaying an opinion of disapproval for an assignment in the opinions of approval or disapproval of the students of group 1 are displayed in discussion content transmission screen 161. The student name, the opinion of approval or disapproval and the influence opinion flag are associated with each other to be displayed in the approval opinion field 162 and the disapproval opinion field 163. In the example of group 1 illustrated in FIG. 16, all of the students have the opinion of approval for the assignment and no student has the opinion of disapproval for the assignment.

Further, a representative opinion input field 164 in which the representative opinion of group 1 determined in the primary discussion is input and an approval or disapproval field 165 in which the approval or disapproval for the assignment of group 1 determined in the primary discussion is input are displayed in the discussion content transmission screen 161. Further, a representative opinion input field 166 in which the representative opinion of group 1 determined in the secondary discussion is input and an approval or disapproval field 167 in which the approval or disapproval for the assignment of group 1 determined in the secondary discussion is input are displayed in the discussion content transmission screen 161.

Also, a transmission button 168 for transmitting the representative opinion and the approval or disapproval determined in the primary discussion to the teacher terminal 200 and a transmission button 169 for transmitting the representative opinion and the approval or disapproval determined in the secondary discussion to the teacher terminal 200 are displayed in the discussion content transmission screen 161.

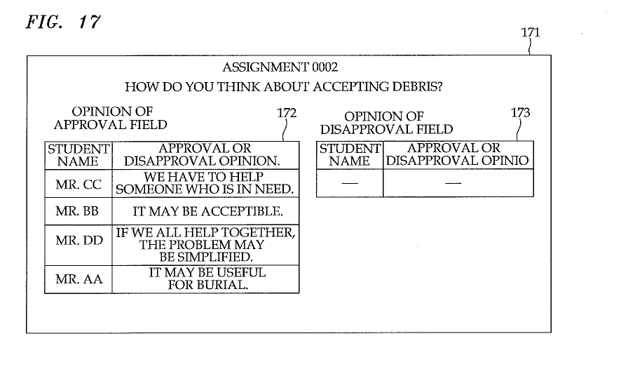

FIG. 17 is a second view illustrating an exemplary discussion content transmission screen of the primary discussion displayed on the student terminal 300. The discussion content transmission screen 171 illustrated in FIG. 17 is a screen displayed in the student terminal 300 of the students except for the student who plays the role of the chairperson among the students of group 1.

An approval opinion field 172 for displaying an opinion of approval for an assignment and a disapproval opinion field 173 for displaying an opinion of disapproval for an assignment in the opinions of approval or disapproval of the students of group 1 are displayed in discussion content transmission screen 171. The student name and the opinion of approval or disapproval are associated with each other to be displayed in each of the approval opinion field 172 and the disapproval opinion field 173.

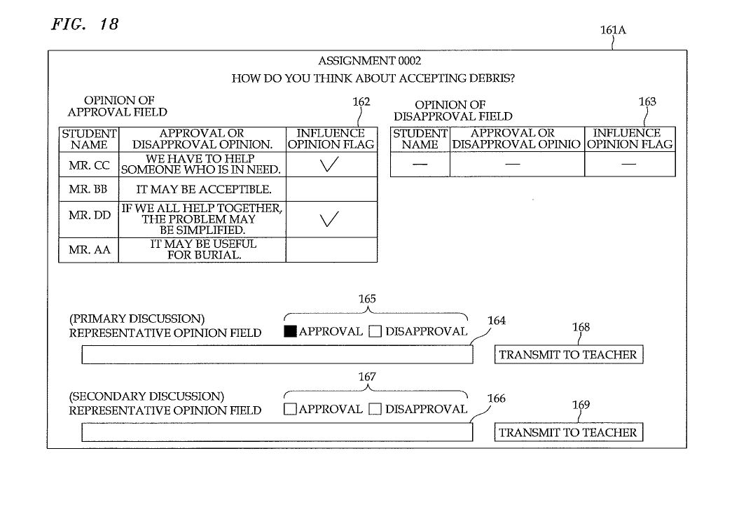

FIG. 18 is a third view illustrating an exemplary discussion content transmission screen of the primary discussion displayed on the student terminal. The discussion content transmission screen 161A of FIG. 18 is a screen displayed in the student terminal 300 of the student who plays the role of the chairperson of group 1 after completion of the primary discussion.

In the discussion content transmission screen 161A, the representative opinion determined in the primary discussion is input in the representative opinion input field 164, and the approval or disapproval for the assignment determined in the primary discussion is selected in the approval or disapproval field 165. Further, in the discussion content transmission screen 161A, the influence opinion flag is set with respect to the opinion of approval or disapproval which is considered as having influenced upon determining the representative opinion in the primary discussion in the influence opinion flag field of the approval opinion field 162 in which the opinion of approval or disapproval of each student is displayed.

When the opinion of approval or disapproval which is determined as an influence opinion in the group is selected, the student who plays the role of the chairperson may select an influence opinion flag associated with the selected opinion of approval or disapproval to set the influence opinion flag in the discussion content transmission screen 161A. The opinion of approval or disapproval of Mr. CC and the opinion of approval or disapproval of Mr. DD are selected as the influence opinions in the discussion content transmission screen 161A illustrated in FIG. 18.

When the student who plays the role of the chairperson manipulates a transmission button 168 in the discussion content transmission screen 161A, the representative opinion and the approval or disapproval that are results of the primary discussion are transmitted to the teacher terminal 200. In this case, the student terminal 300 also transmits the student name or the student ID of the student whose opinion of approval or disapproval is selected as the influence opinion to the teacher terminal 200.

The teacher terminal 200 stores the representative opinion and the approval or disapproval for each group received by the group opinion update unit 265 in the group opinion database 240 (see FIG. 6). Further, the teacher terminal 200 sets the influence opinion flag in the influence opinion flag field associated with the student ID of the student whose opinion of approval or disapproval is selected as the influence opinion in the student opinion database 230 using the student opinion update unit 264.

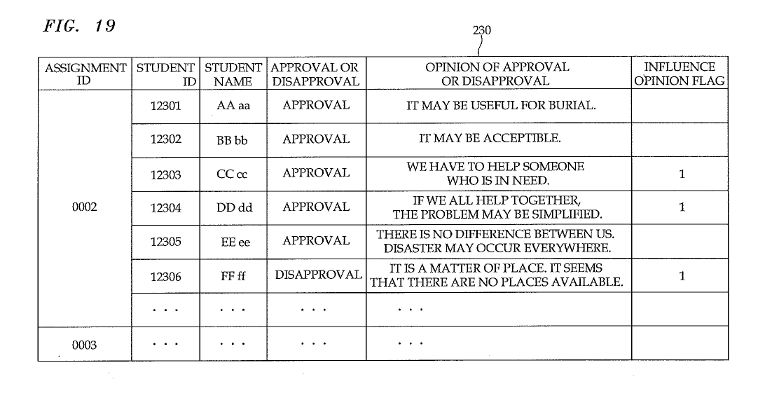

FIG. 19 is a view illustrating an exemplary student opinion database in which an influence opinion flag is set. The students whose opinions of approval or disapprovals are selected as the influence opinion are Mr. CC and Mr. DD in the discussion content transmission screen 161A of FIG. 18. Accordingly, the student opinion update unit 264 sets the influence opinion flag in the influence opinion flag field associated with the student IDs of Mr. CC and Mr. DD of the student opinion database 230. Further, the influence opinion flag is also set in the influence opinion flag field associated with the student ID of Mr. FF whose opinion is selected as the influence opinion in group 2 in the example of the student opinion database 230 illustrated in FIG. 18.

When the primary discussion is completed, and the representative opinion and the approval or disapproval for each group are stored in the group opinion database 240 in all the groups, the teacher terminal 200 causes the display control unit 266 to display the group opinion screen on the display manipulation device 21.

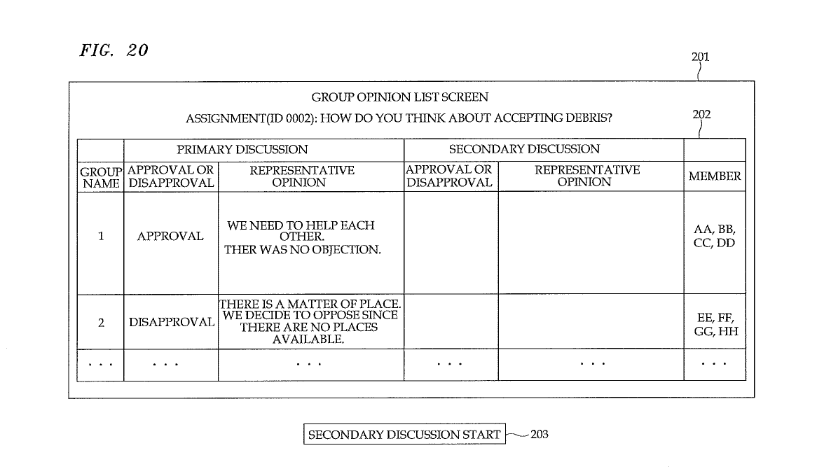

FIG. 20 is a first view illustrating an exemplary group opinion screen displayed on the teacher terminal 200. The group opinion screen 201 of FIG. 20 illustrates a state in which the primary discussion is completed. The assignment selected in the assignment selection screen 121 and the group opinion display field 202 are displayed in the group opinion screen 201. Further, a secondary discussion start button 203 for requesting the start of the secondary discussion is displayed in the group opinion screen 201.

In the group opinion display field 202, the group name, the approval or disapproval and the representative opinion of the group that are results of the primary discussion, the approval or disapproval and the representative opinion of the group that are results of the secondary discussion, and the group members, are displayed to be associated with one another. The example of FIG. 20 illustrates a state in which the primary discussion is completed but the secondary discussion is not yet started, and the approval or disapproval and the representative opinion that are the result of the primary discussion are displayed in the example of FIG. 20.

When the secondary discussion start button 203 is manipulated by the teacher in the group opinion screen 201, the teacher terminal 200 of the present embodiment generates the discussion content transmission screen which urges the start of the secondary discussion. The teacher terminal 200 then transmits the discussion content transmission screen to the student terminal 300 of each group.

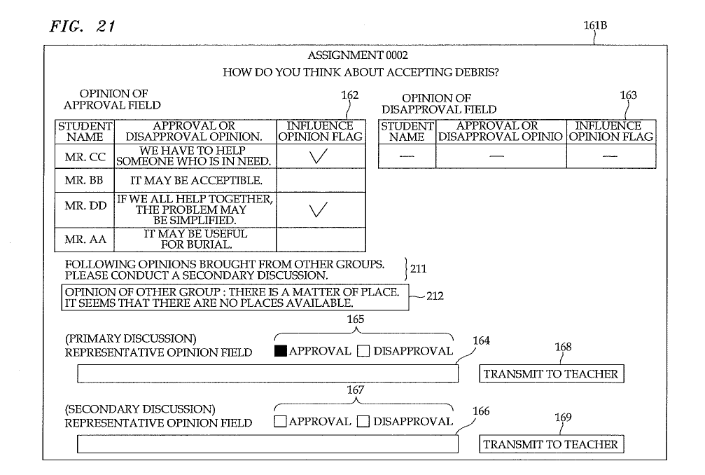

FIG. 21 is a first view illustrating an example of a discussion content transmission screen of a secondary discussion displayed on the student terminal. The discussion content transmission screen 161B of FIG. 21 is a screen displayed on the student terminal 300 of the student who plays the role of the chairperson of group 1 when the starting request of the secondary discussion is received in the teacher terminal 200.

Hereinbelow, generation of the discussion content transmission screen 161B by the teacher terminal 200 will be described with reference to FIG. 3 and FIG. 19.

The approval or disapproval of all the students who belong to group 1 corresponds to the opinion of approval. Accordingly, using the bias detection unit 271, the message notification unit 270 of the teacher terminal 200 determines that the approval or disapproval of group 1 is biased. Further, all the students who belong to group 1 have the opinion of approval and the opinion of disapproval is not present in the opinions within the group.

Accordingly, the flag determination unit 272 determines that the influence opinion flag is not set with respect to the opinion of approval or disapproval of the minority among the opinions within group 1. Subsequently, using the opinion retrieval unit 273, the teacher terminal 200 retrieves in the student opinion database 230 the opinion of approval or disapproval corresponding to an opinion of disapproval which is opposite view to the opinion of group 1 and selected as the influence opinion in the groups other than group 1.

Mr. FF belongs to group 2 and has an opinion of disapproval, and the influence opinion flag is set with respect to Mr. FF in the student opinion database 230 illustrated in FIG. 19. Accordingly, the opinion retrieval unit 273 acquires the opinion of approval or disapproval of Mr. FF as the subject for the secondary discussion.

The screen generation unit 261 of the present embodiment generates the discussion content transmission screen 161B in which the opinion of approval or disapproval acquired as the subject for the secondary discussion and a message which urges the start of the secondary discussion are displayed. The screen generation unit 261 then transmits the discussion content transmission screen 161B to the student terminal 300 of the student who plays the role of the chairperson of group 1.

The message 211 which urges the start of the secondary discussion using the opinion of approval or disapproval of the other group as the subject for discussion and the subject opinion field 212 in which the opinion of approval or disapproval of other groups acquired as the subject for discussion is displayed are displayed on the discussion content transmission screen 161B. The opinion of approval or disapproval of Mr. FF acquired as the subject is displayed in the subject opinion field 212.

As described above, all the students who belong to the group 1 have the viewpoint of an opinion of approval for the assignment and further, the opinion of approval or disapproval selected as the influence opinion which has a viewpoint of an opinion of disapproval is not present in the primary discussion of group 1. In this case, the approval or disapproval and the representative opinion of the group are determined without discussing the assignment deeply from the viewpoint of the opinion of disapproval in the primary discussion of group 1. As a result, it is determined that the discussion is insufficiently conducted in the present embodiment. Accordingly, in the present embodiment, the opinion of approval or disapproval selected as the influence opinion which has an opinion of disapproval in the other group is provided in group 1 as the subject for discussion in order to urge the start of the secondary discussion from the viewpoint of the opinion of disapproval.

That is, in the present embodiment, when a bias toward the approval or disapproval is present within the group, the opinion of approval or disapproval of the other groups having the same approval or disapproval for the assignment as the minority opinion is provided as the subject for the secondary discussion and thus, it is possible to support discussion in order to review the assignment from both viewpoints of the majority and the minority.

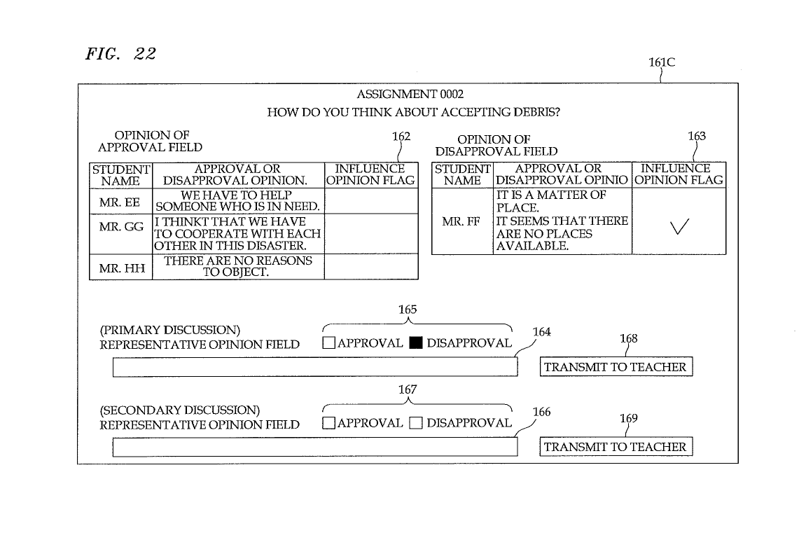

FIG. 22 is a second view illustrating an exemplary discussion content transmission screen of the secondary discussion displayed on the student terminal 300. The discussion content transmission screen 161C illustrated in FIG. 22 is a screen displayed in the student terminal 300 of the student who plays the role of the chairperson of group 2 when the primary discussion is completed.

The opinions of approval for the assignment of three students are displayed in the approval opinion field 162A, and an opinion of disapproval for the assignment of a student is displayed in the disapproval opinion field 163A in the discussion content transmission screen 161C. The influence opinion flag is set with respect to the opinion of approval or disapproval of Mr. FF in the influence opinion flag field of the disapproval opinion field 163A. Further, the approval or disapproval selected as a result of the primary discussion is an opinion of disapproval for the assignment in the discussion content transmission screen 161C.

Under the condition described above, a case where the teacher terminal 200 receives the secondary discussion start request is described in the following.

Three students have the opinion of approval and a student has the opinion of disapproval among the approval or disapproval of the students who belong to group 2. Accordingly, using the bias detection unit 271, the message notification unit 270 of the teacher terminal 200 determines that the approval or disapproval of group 2 is biased.

Subsequently, the flag determination unit 272 determines whether the influence opinion flag is set with respect to the opinion of approval or disapproval of the minority among the opinions of group 2. The opinion of approval or disapproval of the minority among the opinions of group 2 is an opinion of disapproval for the assignment, and the influence opinion flag is set with respect to the opinion of approval or disapproval.

In the present embodiment, when the influence opinion flag is set with respect to the opinion of approval or disapproval of the minority, it is determined that the discussion from the viewpoint of the minority is sufficiently conducted. Accordingly, the teacher terminal 200 does not retrieve the opinion of approval or disapproval using the opinion retrieval unit 273 and does not provide (display) the subject for the secondary discussion in group 2. In this case, the teacher terminal 200 may display only the message which urges the start of the secondary discussion in the discussion content transmission screen 161C.

When the secondary discussion is conducted in each group and the teacher terminal 200 receives the approval or disapproval and the representative opinion of the results of the secondary discussion, the group opinion update unit 265 stores the received approval or disapproval and the representative opinion in the group opinion database 240.

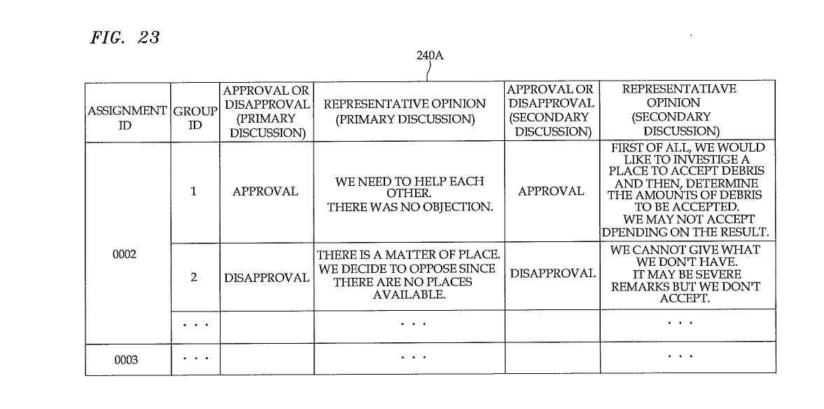

FIG. 23 is a view illustrating an exemplary group opinion database in which the result of the secondary discussion is stored. The approval or disapproval and the representative opinion that are the results of the secondary discussion are stored for each group in the group opinion database 240A illustrated in FIG. 23.

When the results of the secondary discussion of all the groups are stored in the group opinion database 240, the teacher terminal 200 causes the display control unit 266 to display the group opinion screen on the display manipulation device 21.

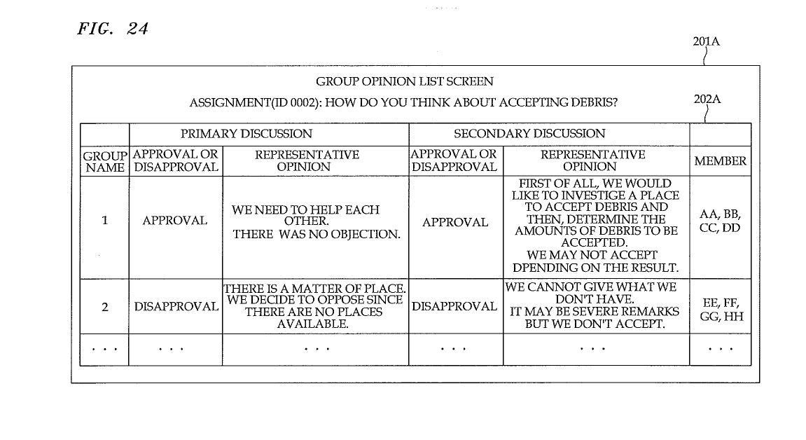

FIG. 24 is a second view illustrating an example of the group opinion screen displayed on the teacher terminal. The group opinion screen 201A of FIG. 24 is a screen in a state where the secondary discussion is completed. The assignment selected in the assignment selection screen 121 and the group opinion display field 202A are displayed on the group opinion screen 201A. The group name, the approval or disapproval and the representative opinion of the group that are the results of the primary discussion, the approval or disapproval and the representative opinion of the group that are the results of the secondary discussion, and group members are displayed on the group opinion display field 202A.

Further, the secondary discussion has been completed and thus, the secondary discussion start button 203 for requesting the start of the secondary discussion is not displayed in the group opinion screen 201A.

In the present embodiment as described above, it is determined whether the discussion regarding the assignment is sufficiently conducted from both viewpoints of approval and disapproval based on the ratio of the approval or disapproval for the assignment within the group and the approval or disapproval of the opinion of approval or disapproval selected because the opinion of approval or disapproval has influenced on determination of the representative opinion. Also, when it is determined that the discussion is insufficiently conducted, an opinion of a group having the approval or disapproval which is opposite to the representative opinion of another group is provided as the subject for discussion to cause the discussion to be conducted again, such that it is possible to support the discussion in order to retrieve the assignment from both viewpoints of approval and disapproval.

In the meantime, in the description described above, the representative opinion of the group is input in the representative opinion field 164 of the discussion content transmission screen 161 displayed in the student terminal 300 of a student who plays the role of the chairperson of the group, but is not limited thereto. The representative opinion of the group may be selected from, for example, the opinion of approval or disapproval of the student who belongs to the group.

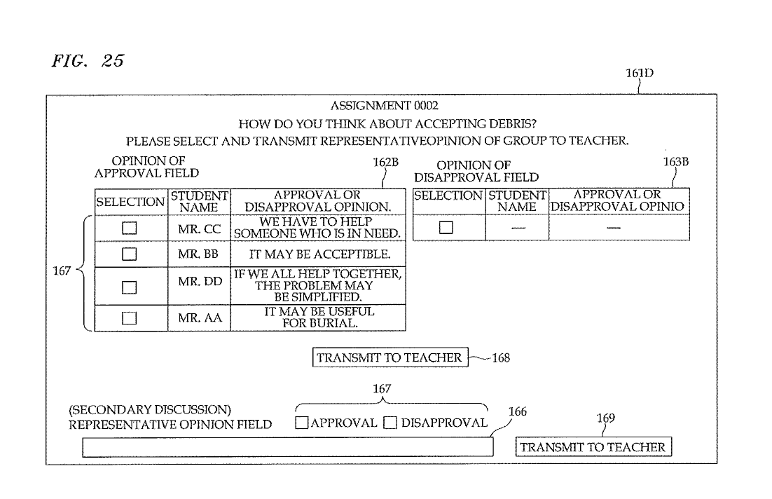

FIG. 25 is a fourth view illustrating an exemplary discussion content transmission screen of the primary discussion displayed on the student terminal 300.

The representative opinion selection fields 251 and 252 are provided in the approval opinion field 162B and the disapproval opinion field 163B of the discussion content transmission screen 161D illustrated in FIG. 25, respectively, instead of the influence opinion flag field. In the example of FIG. 25, the selected opinion in the representative opinion selection fields 251, 252 becomes a representative opinion in the discussion content transmission screen 161D. In this case, a flag may be set in the influence opinion flag field associated with the student ID of the student having an opinion selected as the representative opinion in the student opinion database 230.

Although not illustrated in FIG. 25, the influence opinion flag field may also be provided in the discussion content transmission screen 161D in addition to the representative opinion selection fields 251, 252. In this case, the flag may be set in the influence opinion flag field associated with the student ID of the student having an opinion selected as the representative opinion and in the influence opinion flag field associated with the student ID of the student having an opinion selected as the influence opinion in the student opinion database 230.

As described above, in the present embodiment, when there is bias in the approval or disapproval within the group, the opinion of approval or disapproval of another group having the same approval or disapproval as that of the minority opinion is provided as the subject for the secondary discussion, such that it is possible to cause the discussion to be conducted from both viewpoints of approval and disapproval. Accordingly, in the present embodiment, for example, a cumbersome work that the teacher confirms the approval or disapproval of the representative opinion of each group to present the opinion of approval or disapproval which is opposite to that of the representative opinion as the subject for the secondary discussion for each group, may be omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable storage medium storing a computer executable program that, when executed, causes a computer to perform a method for learning support comprising:
collecting a first opinion information and a second opinion information from a plurality of information terminals of a group;
determining whether a representative opinion information of a group is included in a majority opinion information among collected opinion information of the first opinion information and the second opinion information; and
outputting a minority opinion information among the collected opinion information when the representative opinion information is included in the majority opinion information.

2. The computer-readable storage medium according to claim 1, wherein the method for learning support further comprising:
detecting whether a bias is present in opinions collected within the group based on ratio of the first opinion information and the second opinion information collected from a plurality of information terminals within the group,
wherein the determining determines whether the representative opinion information is included in the majority opinion information in the group when the bias is detected in the opinions collected within the group.

3. The computer-readable storage medium according to claim 2, wherein the method for learning support further comprising:
collecting a first opinion information and a second opinion information from a plurality of information terminals that belong to another group,
wherein the outputting generates a screen which includes an opinion information of the another group corresponding to the minority opinion information of the group, among the first opinion information and the second opinion information collected from the plurality of information terminals that belong to the another group, and a message urging a discussion; and
transmitting the screen to any one of the plurality of information terminals of the group.

4. The computer-readable storage medium according to claim 3, wherein the outputting refers to the collected opinion information of the first opinion information and the second opinion information as well as a storage unit in which each of the collected opinion information of the first opinion information and the second opinion information is associated with a flag field that indicates whether an opinion information associated with the flag field has influenced upon determination of the representative opinion information, and
the outputting is performed when a flag is not set in the flag field associated with the minority opinion information among the first opinion information and the second opinion information collected from the plurality of information terminals of the group.

5. The computer-readable storage medium according to claim 4, wherein the outputting further comprising:
referring to the storage unit; and
generating a screen in which an opinion information corresponding to the minority opinion information among the first opinion information and the second opinion information of the group and being set with the flag is included in the first opinion information and the second opinion information collected from the plurality of information terminals of the another group.

6. The computer-readable storage medium according to claim 1, wherein each of the first opinion information and the second opinion information indicates either an opinion of approval or an opinion of disapproval for the content of an assignment displayed by assignment data selected from an assignment storage unit where the assignment data are stored.

7. A device for learning support comprising:
a collecting unit configured to collect a first opinion information and a second opinion information from a plurality of information terminals of a group;
a determination unit configured to determine whether a representative opinion information of a group is included in a majority opinion information among collected opinion information of the first opinion information and the second opinion information; and
an output unit configured to output a minority opinion information among the collected opinion information when the representative opinion information is included in the majority opinion information.

8. The device according to claim 7, further comprising:
detecting unit that detects whether a bias is present in opinions collected within the group based on ratio of the first opinion information and the second opinion information collected from a plurality of information terminals within the group,
wherein the determination unit determines whether the representative opinion information is included in the majority opinion information in the group when the bias is detected in the opinions collected within the group.

9. The device according to claim 8, wherein the collecting unit collects a first opinion information and a second opinion information from a plurality of information terminals that belong to another group; and
the outputting unit generates a screen which includes an opinion information of the another group corresponding to the minority opinion information of the group, among the first opinion information and the second opinion information collected from the plurality of information terminals that belong to the another group, and a message urging a discussion, and transmits the screen to any one of the plurality of information terminals of the group.

10. The device according to claim 9, wherein the outputting unit refers to the collected opinion information of the first opinion information and the second opinion information as well as a storage unit in which each of the collected opinion information of the first opinion information and the second opinion information is associated with a flag field that indicates whether an opinion information associated with the flag field has influenced upon determination of the representative opinion information, and performs the outputting process when a flag is not set in the flag field associated with the minority opinion information among the first opinion information and the second opinion information collected from the plurality of information terminals of the group.

11. The device according to claim 10, wherein the outputting unit refers to the storage unit; and generates a screen in which an opinion information corresponding to the minority opinion information among the first opinion information and the second opinion information of the group and being set with the flag is included in the first opinion information and the second opinion information collected from the plurality of information terminals of the another group.

12. The device according to claim 7, wherein each of the first opinion information and the second opinion information indicates either an opinion of approval or an opinion of disapproval for the content of an assignment displayed by assignment data selected from an assignment storage unit where the assignment data are stored.

13. A method for learning support comprising:
collecting a first opinion information and a second opinion information from a plurality of information terminals of a group;
determining whether a representative opinion information of a group is included in a majority opinion information among collected information of the first opinion information and the second opinion information; and
outputting a minority opinion information among the collected opinion information when the representative opinion information is included in the majority opinion information.

14. The method according to claim 13, further comprising:
detecting whether a bias is present in opinions collected within the group based on ratio of the first opinion information and the second opinion information collected from a plurality of information terminals within the group,
wherein the determining determines whether the representative opinion information is included in the majority opinion information in the group when the bias is detected in the opinions collected within the group.

15. The method according to claim 14, further comprising:
collecting a first opinion information and a second opinion information from a plurality of information terminals that belong to another group,
wherein the outputting generates a screen which includes an opinion information of the another group corresponding to the minority opinion information of the group, among the first opinion information and the second opinion information collected from the plurality of information terminals that belong to the another group, and a message urging a discussion; and
transmitting the screen to any one of the plurality of information terminals of the group.

16. The method according to claim 15, wherein the outputting refers to the collected opinion information of the first opinion information and the second opinion information as well as a storage unit in which each of the collected opinion information of the first opinion information and the second opinion information is associated with a flag field that indicates whether an opinion information associated with the flag field has influenced upon determination of the representative opinion information, and
the outputting is performed when a flag is not set in the flag field associated with the minority opinion information among the first opinion information and the second opinion information collected from the plurality of information terminals of the group.

17. The method according to claim 16, wherein the outputting further comprising:
referring to the storage unit; and
generating a screen in which an opinion information corresponding to the minority opinion information among the first opinion information and the second opinion information of the group and being set with the flag is included in the first opinion information and the second opinion information collected from the plurality of information terminals of the another group.

18. The method according to claim 13, wherein each of the first opinion information and the second opinion information indicates either an opinion of approval or an opinion of disapproval for the content of an assignment displayed by assignment data selected from an assignment storage unit where the assignment data are stored.
